(19) United States
(12) Patent Application Publication
(10) Pub. No.: US 2004/0104544 A1
(43) Pub. Date: Jun. 3, 2004

(54) HIGH TEMPERATURE GAS SEALS

(76) Inventors: Jen-Jung FAN, Calgary (CA); Jian LI, Calgary (CA); Debabrata GHOSH, Calgary (CA); Robert BRULE, Calgary (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/604,460

(22) Filed: Jul. 23, 2003

Related U.S. Application Data
(60) Provisional application No. 60/319,418, filed on Jul. 23, 2002.

(51) Int. Cl. F16J 15/10

(52) U.S. Cl. 277/650; 264/131

(57) ABSTRACT

A flexible seal for use in a solid oxide fuel cell stack is formed from a ceramic fibre matrix impregnated with a plurality of metallic or semi-metallic particles which are then converted to a corresponding ceramic particle, such as by oxidation. The seal may be formed by dipping the fibre matrix into a slurry, suspension or sol-gel of the particles in an alcohol, and then firing the seal to oxidize the metal particles. The seal may also be formed by tape casting a slurry formed from metallic or semi-metallic particles, ceramic fibres and/or ceramic particles.

### CROSS REFERENCE TO RELATED APPLICATIONS

This application claims the priority benefit of U.S. Provisional Application No. 60/319,418 filed on Jul. 23, 2002 entitled “High Temperature Gas Seals”, the contents of which are incorporated herein by reference

### BACKGROUND OF INVENTION

The present invention relates to high temperature gas seals, particularly for use in the cells of a solid oxide fuel cell stack.

A planar solid oxide fuel cell (SOFC) stack has three primary constituents: a ceramic electrochemical cell membrane, interconnect plates, and an arrangement of seals. To perform the function of converting chemical energy into electrical energy, a SOFC membrane must have one electrochemical face exposed to an oxidant gas, and the other exposed to a fuel gas, all at an operating temperature at or above 600° C. An interconnect plate, which is typically metallic, provides fuel and oxidant gas distribution to the cells by means of separate plenums, and when arranged between cells in a fuel cell stack arrangement, also transfers electrical current from one cell to another. The seals required between a cell and an interconnect in a SOFC stack must provide adequate resistance to gas permeation to contain the reactants within the gas distribution plenum, while maintaining adequate physical, chemical and mechanical properties. This includes properties such as matching thermal expansion coefficients and resistance to chemical reaction and diffusion with the components to be sealed and with the hostile operating environment of a SOFC. The seals must also be able to withstand several thermal cycles from room to operating temperatures which may exceed 1000° C.

Conventional sealing methods all have disadvantages for use in planar SOFC stacks. Most prior art seals are formed from glass which has been crystallized between the two members to be sealed, forming a brittle gas tight seal. The difficulties with glass seals arises from the need to thermally cycle the stack from room temperature to operating temperatures. The various stack components tend not to have their coefficients of thermal expansion perfectly matched, thus stresses arise during thermal cycling of the stack. Even if the coefficients of thermal expansion are matched, the rates of thermal conductivities within a stack are typically not matched, resulting in non-uniform thermal expansion. As glass is inherently brittle, it cracks and fails under thermal cycling conditions. The brittleness of glass also makes glass seals subject to failure as a result of jarring shocks or vibrations. This is often the case in fuel cells used in motor vehicles.

Other prior art seals have been made of mica, and while being able to withstand the high temperature, they are typically unable to provide an adequate seal to keep the fuel and oxidant gases separated. Further problems have been found with the natural variance in thickness of mica sheets and the relative non-compressibility of the mica. Both of these factors prevent an effective seal from forming.

A further disadvantage of glass seals is chemical incompatibility with electrocatalytic cells, which leads to power degradation under operation. A SOFC is particularly sensitive to alkali elements contained in many glass seals which can detrimentally affect the SOFC catalyst. At the high temperatures required, chemical reaction and diffusion rates of seal elements into the components can increase dramatically. Glass seals and other prior art seals, such as mica, are chemically incompatible with SOFCs due to the large number of components (such as alkali elements) that can diffuse into the components to be sealed and degrade their performance.

Therefore, there is a need in the art for a seal suitable for use in a SOFC which mitigates the difficulties found in the prior art.

### SUMMARY OF INVENTION

The present invention is directed to a gasket type sealing element for sealing the cells in a SOFC from each other which are effective under the harsh operating environment in which the cells are required to operate. The seal comprises ceramic material in the form of a ceramic component and a reactive component which has been converted to a ceramic material.

In one aspect, the invention comprises a method of forming a high-temperature gas seal comprising the steps of:

(a)combining a ceramic component with a reactive component;

(b)installing the seal in between first and second contact surfaces; and

(c)converting the reactive component to a corresponding ceramic material in situ.

In one preferred embodiment, the conversion may be an oxidative process which take places in the fuel cell stack at operating temperatures. Using this preferred method, a bond between the seal and the adjacent components is created due to diffusion which occurs at the operating temperature of the fuel cell. As well, the oxidation reaction may enhance the strength of the seal by reaction-bonding the particles to each other and to the ceramic component. Any unreacted metal may be coated by an oxide coating which provides desired electrical resistance.

In another aspect, the invention may comprise a seal which comprises a reactive component and a ceramic component, wherein the reactive component may be converted to a corresponding ceramic material in situ. In yet another aspect, the invention may comprise a seal which comprises a reactive component and a ceramic component, wherein the reactive component comprises a ceramic material which has been converted from a metallic, semi-metallic mor metal precursor aterial to a corresponding ceramic material in situ.

### DETAILED DESCRIPTION

The present invention provides a flexible seal suitable for use in a solid oxide fuel cell stack operating in excess of 600° C. and experiencing thermal cycles. When describing the present invention, the following terms have the following meanings, unless indicated otherwise. All terms not defined herein have their common art-recognized meanings. The term “fibre” refers to a ceramic component having an aspect ratio of greater than 2:1, preferably greater than about 5:1 and more preferably greater than about 10:1.

The term “ceramic” refers to inorganic non-metallic solid materials with a prevalent covalent or ionic bond including, but not limited to metallic oxides (such as oxides of aluminium, silicon, magnesium, zirconium, titanium, chromium, lanthanum, hafnium, yttrium and mixtures thereof) and non-oxide compounds including but not limited to carbides (such as of titanium, tungsten, boron, silicon), suicides (such as molybdenum disicilicide), nitrides (such as of boron, aluminium, titanium, silicon) and borides (such as of tungsten, titanium, uranium) and mixtures thereof; spinels, titanates (such as barium, lead, lead zirconium titanates, strontium titanate, iron titanate), ceramic super conductors, zeolites, ceramic solid ionic conductors (such as yittria stabilized zirconia, beta-alumina and cerates).

In general terms, the seals of the present invention comprise a reactive component and a ceramic component. The reactive component is converted to a ceramic material once the seal has been formed into a desired shape.

The ceramic component may comprise ceramic particles, ceramic fibres or a combination of ceramic particles and fibres. The resulting seal is similar to that described in Applicant's co-pending U.S. patent application Ser. No. 09/931,415 filed on Aug. 17, 2001, the contents of which are incorporated herein by reference.

The reactive component may comprise metallic or semi-metallic particles, or metal precursors such as nitrides, acetates, chlorides, carbonate, alkoxides and so on. The metallic or semi-metallic particles may comprise powders of aluminium, zirconium, yttrium, titanium, calcium, magnesium or silicon, or mixtures thereof. Each of these may be reacted or converted to a corresponding ceramic material such as alumina, zirconia, yttria, titania, calcium oxide, or magnesium oxide by heating the reactive component in the present of a reactive species such as oxygen.

In one embodiment, and in general terms, the seal is manufactured by combining metallic or semi-metallicparticles, or metal precursor particles, with a ceramic component and forming a seal. The ceramic component may comprise ceramic particles, or ceramic particles combined with ceramic fibres. The seal may then be heat treated to convert the metal or metal precursor particles to a ceramic material, such as an oxide. Preferably, the seal is heat treated subsequent to installation between two contact surfaces. Upon in situ conversion, the particles expand to fill the pores and voids that have been penetrated. As used herein, “in situ conversion” refers to the process of converting the reactive component to its ceramic counterpart within the fuel cell stack, after the stack has been assembled with the seals in place.

Conversion of the reactive component to the corresponding ceramic material will, in most cases, result in volume expansion and a corresponding decrease in porosity of the seal. This conversion permits a greater reduction in porosity than prior art techniques. For example, in a standard impregnation of alumina felt with alumina particles, the porosity decreases from approximately above 85% to approximately 55%. However, if the same felt is loaded with aluminium particles followed by oxidation to alumina, the porosity can be reduced to less than 40%, and can be tailored to arrive at any final porosity between that and the original porosity of the ceramic felt. A porosity of 15 to 35% is more preferred.

In addition to the volume change of the particles, some degree of chemical bonding occurs between the converted particles themselves and between the ceramic component and the converted particles. Furthermore, some reaction bonding or diffusion bonding occurs between the seal and the stack contact surfaces.

In one preferred embodiment, the reactive component comprises aluminium powder that is preferably smaller than 10 microns in size. The ceramic component may comprise alumina particles and alumina fibres. In another embodiment, the metal particles comprise aluminium and the ceramic component comprises alumina particles substantially free of alumina fibres.

In practice, the use of a large amount of metallic particles such as aluminium will result in too large a volumetric change of the seal, particularly if the seal is converted in situ. Therefore, in a preferred embodiment, the metallic particles are combined with ceramic particles. In one embodiment, about 5% to about 25% by volume of the particles are metallic, while the remainder are ceramic. The greater the percentage of metallic particles, the greater the volume change upon conversion, with a corresponding decrease in porosity. In a preferred embodiment, about 10% to about 15% of the particles are metallic.

The basis for the decreased porosity is two-fold. Firstly, upon heating in the presence of oxygen, the aluminium will be oxidized to an aluminium oxide and expand 30% or more by volume and further fill the voids between the fibres of the alumina felt. And, secondly, metal particles in nearby pores will come into contact with each other and with the ceramic fibres and particles on expansion and bond to one another by reaction, giving the seal both greater physical strength and density.

Greater physical strength allows the gasket seal to be handled during component assembly. The use of a metallic precursor, for example, may allow even greater bonding strength with the ceramic fibres. The seal does not, however, strongly bond with the contact surfaces due to lack of diffusion. In the absence of significant bonding with the contact surfaces, there is little concern with matching the thermal expansion coefficient of the contact surfaces and the seal. The diffusion bonding does however reduce the interface leak rate without increasing the risk of fracture due to differing thermal expansion coefficients. This bonding also decreases the likelihood of seal blow-out.

Any ceramic material can be manufactured in this, especially the elements in the group 3A and 3B and some 2A and 4B elements on the periodic table, including aluminium/alumina, silica/silicon, zirconia/zirconium, titania/titanium and magnesia/magnesium. Any combination of elements can be used to modify the properties of the seal, such as, for example, a combination of silicon and aluminium powder. In another example, a Group 2 element such as calcium or magnesium may be mixed with the aluminium powder to form the reactive component.

The high temperature, reaction-bonded seal can be manufactured by any suitable techniques to attain the proper mix of properties for the application. One method involves impregnating a pre-manufactured felt with the metal powder. It also can be done by mixing ceramics and metal powder directly prior to reaction-bonding. In general, the process can include all known wet techniques, such as slurry dipping, slip casting, pressurized slurry impregnation, slurry tape casting, or any other process that puts the metal powder in a wet and flowable form that can be applied to form the composite. The liquid used for preparing the slurry or solution can also contain the reactive metal element, such as a sol-gel solution. The seal can then be oxidized, carburised, nitrided, or otherwise reacted in any gas environment necessary to attain the final desired ceramic material. This reaction-bonding step can be carried out in situ, in a hot pressing apparatus or any other environment that will provide the desired material characteristics.

In one embodiment, the ceramic component may comprise a sheet of alumina Kaowool™ and the metallic particles may comprise aluminium metal powder with a sub-micron average particle size. The Kaowool™ is dipped in an alcohol suspension of the aluminium powder. The sheet may then be dried, cut to size, and placed in compression between the components to be sealedand then heated to the operating temperature of the fuel cell, where in-situ oxidation of the aluminium may take place.

Alternatively, a sheet of zirconia felt may be impregnated with a colloid solution of sub-micron sized zirconium particles. It is preferred to use a ceramic component which is the corresponding ceramic material of the metallic particles. However, it is possible and within the scope of the present invention to mix elements such as aluminium with zirconia.

In an alternative embodiment, a titanium nitride felt may be impregnated with a colloid solution of titanium particles. The felt may be then be dried, exposed to a nitriding environment under pressure until the titanium is reacted. The seal can alternatively be compressed between the components to be sealed prior to nitriding.

In an alternative embodiment, the reactive component comprising metal powder, and ceramic component comprising ceramic powder and ceramic fibres may be mixed with suitable plasticizers, dispersants and binders so that the seal may be tape cast, and then compressed in green form between the parts to be sealed.

### EXAMPLES

The following examples are intended to exemplify embodiments of the invention and are not limiting of the claimed invention in any manner. One skilled in the art may vary the components or their proportions to achieve a desired result within the scope of the invention.

### Example 1

### Tape Cast Seal Formulations with Alumina Fibre

Alumina powder and fiber (Saffil HA™) was mixed with aluminium powders using a binder (Butvar B-76™), a plasticizer (Santicizer-160™), a dispersant (Emphos PS 236) and solvent (61:34:5 mixture of toluene, methyl i-butyral ketone and absolute anhydrous ethanol), to create the tape casting slurry

TABLE 1

| | | | | | | Volume |
|---|---|---|---|---|---|---|
| | | kg of | | | | % |
| | Density | mate- | | Volume | Volume | of Metal/ |
| | g/cm3 | rial | Wt % | in ml | % | Ceramic |
| Alumina | 4 | 0.9 | 42.5 | 225 | 19.74 | 59.97 |
| Fiber (Saffil HA) | 4 | 0.3 | 14.17 | 75 | 6.58 | 19.99 |
| Aluminium | 2.7 | 0.203 | 9.59 | 75.19 | 6.6 | 20.04 |
| Powder | | | | | | |
| Butvar B-76 | 1.08 | 0.075 | 3.54 | 69.44 | 6.09 | |
| Sant-160 | 1.12 | 0.129 | 6.09 | 115.18 | 7.83 | |
| Emphos PS 236 | 1 | 0.011 | 0.5 | 10.5 | 0.92 | |
| Toluene/MIBK/ | 0.84 | 0.5 | 23.61 | 595.24 | | |
| ETOH | | | | | | |

The resulting seal, excluding the organic components, prior to conversion, comprises

TABLE 4

| | | | | | | Volume |
|---|---|---|---|---|---|---|
| | | kg of | | | | % |
| | Density | mate- | | Volume | Volume | of Metal/ |
| | g/cm3 | rial | Wt % | in ml | % | Ceramic |
| Alumina | 4 | 0.9 | 900 | 225 | 24.67 | 74.95 |
| Fiber (Saffil HA) | 4 | 0 | | 0 | 0 | 0 |
| Aluminium | 2.7 | 0.203 | 203 | 75.19 | 8.24 | 25.05 |
| Powder | | | | | | |
| Butvar B-76 | 1.08 | 0.075 | 75 | 69.44 | 7.61 | |
| Sant-160 | 1.12 | 0.129 | 129 | 115.18 | 12.63 | |
| Emphos PS 236 | 1 | 0.011 | 10.5 | 10.5 | 1.15 | |
| Toluene/MIBK/ | 0.84 | 0.35 | 350 | 416.67 | 45.69 | |
| ETOH | | | | | | |

TABLE 5

| | | | | | | Volume |
|---|---|---|---|---|---|---|
| | | kg of | | | | % |
| | Density | mate- | | Volume | Volume | of Metal/ |
| | g/cm3 | rial | Wt % | in ml | % | Ceramic |
| Alumina | 4 | 0.6 | 61.76 | 150 | 29.75 | 84.38 |
| Fiber (Saffil HA) | 4 | 0 | 0 | 0 | 0 | 0 |
| Aluminium | 2.7 | 0.075 | 7.72 | 27.78 | 5.51 | 15.63 |
| Powder | | | | | | |
| Butvar B-76 | 1.08 | 0.045 | 4.63 | 41.67 | 8.26 | |
| Sant-160 | 1.12 | 0.045 | 4.63 | 40.18 | 7.97 | |
| Emphos PS 236 | 1 | 0.007 | 0.67 | 6.5 | 1.29 | |
| Toluene/MIBK/ | 0.84 | 0.2 | 20.59 | 238.1 | 47.22 | |
| ETOH | | | | | | |

TABLE 6

| | | | | | | Volume |
|---|---|---|---|---|---|---|
| | | kg of | | | | % |
| | Density | mate- | | Volume | Volume | of Metal/ |
| | g/cm3 | rial | Wt % | in ml | % | Ceramic |
| Alumina | 4 | 0.600 | 63.73 | 150.00 | 30.42 | 90.00 |
| Fiber (Saffil HA) | 4 | 0.000 | 0.00 | 0.00 | 0.00 | 0.00 |
| Aluminium | 2.7 | 0.045 | 4.78 | 16.67 | 3.38 | 10.00 |
| Powder | | | | | | |
| Butvar B-76 | 1.08 | 0.045 | 4.78 | 41.67 | 8.45 | |
| Sant-160 | 1.12 | 0.045 | 4.78 | 40.18 | 8.15 | |
| Emphos PS 236 | 1 | 0.007 | 0.69 | 6.50 | 1.32 | |
| Toluene/MIBK/ | 0.84 | 0.200 | 21.24 | 238.10 | 48.28 | |
| ETOH | | | | | | |

The specific methods of forming the seals described herein are not intended to limit the claimed invention unless specifically claimed in that manner below.

As will be apparent to those skilled in the art, various modifications, adaptations and variations of the foregoing specific disclosure can be made without departing from the scope of the invention claimed herein.

1. A method of forming a high-temperature gas seal comprising the steps of:
(a)combining a ceramic component with a reactive component;
(b)installing the seal in between first and second contact surfaces; and
(c)converting the reactive component to a corresponding ceramic material in situ.

2. The method of claim 1 wherein the reactive component bonds to itself, to the ceramic component and to the first and second contact surfaces during conversion.

3. The method of claim 1 wherein the ceramic component comprises a ceramic felt or paper or ceramic particles and wherein the reactive component comprises metal particles or metal precursors and wherein the ceramic particles and the metal particles are impregnated within the ceramic felt or paper by dipping the felt or paper into a slurry comprising the ceramic particles and the metal particles.

4. The method of claim 2 wherein the metal particles is selected from the group consisting of aluminium, titanium, silicon, magnesium and zirconium.

5. The method of claim 1 wherein the conversion of the reactive component comprises oxidation of the reactive component with a volumetric increase.

6. The method of claim 1 wherein the reactive component and the ceramic component are mixed in a suitable slurry formulation and the seal is formed by tape-casting or slip casting.

7. The method of claim 3 wherein the metal particles comprise aluminium and the ceramic component comprises alumina.

8. A high-temperature gas seal formed by the method of claim 1, 2, 3, 4, 5, 6 or 7.

9. A seal comprising a reactive component and a ceramic component, wherein the reactive component may be converted to a corresponding ceramic material in situ.

10. The seal of claim 9 wherein the reactive component comprises metallic, semi-metallic or metal precursor particles and wherein the ceramic component comprises ceramic particles.

11. The seal of claim 10 wherein the reactive component particles are selected from the group consisting of aluminium, zirconium, yttrium, titanium, calcium, magnesium and silicon, or mixtures thereof.

12. The seal of claim 11 wherein the reactive component particles comprise aluminium particles and wherein the ceramic component comprises alumina particles.

13. The seal of claim 12 wherein the ceramic component further comprises alumina fibres.

14. A seal comprising a reactive component and a ceramic component, wherein the reactive component comprises a ceramic material which has been converted from a metallic, semi-metallic or metal precursor material to a corresponding ceramic material in situ.
